(19) United States
(12) Patent Application Publication
(10) Pub. No.: US 2009/0171024 A1
(43) Pub. Date: Jul. 2, 2009

(54) PREPARATION OF BLOCK COPOLYMERS

(75) Inventors: Wojciech Jakubowski, Pittsburgh, PA (US); James Spanswick, Wheaton, IL (US); Laura Mueller, Pittsburgh, PA (US); Krzysztof Matyjaszewski, Pittsburgh, PA (US)

Correspondence Address: K&L GATES LLP, 535 SMITHFIELD STREET, PITTSBURGH, PA, 15222, US

(73) Assignee: CARNEGIE MELLON UNIVERSITY, PITTSBURGH, PA (US)

(21) Appl. No.: 12/158,471

(22) PCT Filed: Dec. 20, 2006
(86) PCT No.: PCT/US2006/048656

§ 371 Date: Sep. 19, 2008

Related U.S. Application Data
(60) Provisional application No. 60/752,684, filed on Dec. 21, 2005.

(51) Int. Cl. C08L 53/00

(52) U.S. Cl. 525/94

(57) ABSTRACT

The present invention is directed towards a polymerization process for the preparation of block copolymers. In an embodiment, the polymerization process may comprise low levels of catalyst in an oxidized state that react with a reducing agent to form an active catalyst. Embodiments of the process surprisingly use low levels of catalysts and allow formation of the all blocks with the same catalyst. The catalyst may be deactivated and reactivated to form each block. In one embodiment of the invention, the catalyst is oxidized to the deactivator state when the desired degree of polymerization of a polymer segment or block is reached. The first monomer may be removed prior to addition of the second monomer. The catalyst may then be reactivated for preparation of a second block. A further embodiment may include addition of second radically polymerizable monomer to provide efficient initiation of the macroinitiator to transition from polymerization of the first block or segment to polymerization of a second block or blocks.

### TECHNICAL FIELD OF THE INVENTION

The present invention is directed towards a polymerization process for the preparation of block copolymers. In an embodiment, the polymerization process may comprise low levels of catalyst in an oxidized state that react with a reducing agent to form an active catalyst. The reduced catalyst activates a compound comprising a radically transferable atom or group to initiate and/or maintain catalytic activity throughout each stage of the polymerization process. In one embodiment of the invention, the catalyst is oxidized to the deactivator state when the desired degree of polymerization of a polymer segment or block is reached. The first monomer may be removed prior to addition of the second monomer. The catalyst may then be reactivated for preparation of a second block. A further embodiment may include addition of second radically polymerizable monomer to provide efficient initiation of the macroinitiator to transition from polymerization of the first block or segment to polymerization of a second block or blocks.

### BACKGROUND OF THE INVENTION

Controlled radical polymerization (CRP) processes have gained increasing attention because CRP couples the advantage afforded by conventional free radical polymerization (RP) of (co)polymerizing a wide range of monomers with the ability to synthesize polymeric materials with predetermined molecular weight (MW), low polydispersity (PDI), controlled composition, site specific functionality, selected chain topology and incorporate bio- or inorganic species into the final product. The three most studied, and promising, methods of controlling radical polymerization are nitroxide mediated polymerization (NMP), atom transfer radical polymerization (ATRP), and degenerative transfer with dithioesters via reversible addition-fragmentation chain transfer polymerization (RAFT). Each of these methods relies on establishment of a dynamic equilibrium between a low concentration of active propagating chains and a predominant amount of dormant chains that are unable to propagate or terminate as a means of extending the lifetime of the propagating chains. The most widely applied CRP process is ATRP.

Typically, ATRP processes comprise a transition metal complex. The transition metal complex may participate in a repetitive redox reaction homolytically removing a transferable atom or group from an initiator molecule or dormant polymer chain, Pₙ—X, to form the active propagating species, P^{•}ₙ, and then deactivating the active propagating species, P^{•}ₙ₊, by donating back a transferable atom or group, not necessarily the same atom or group from the same transition metal complex. (Scheme 1)

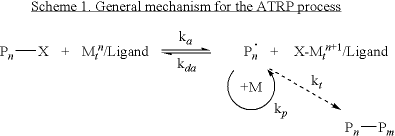

The transition metal catalyst for this repetitive atom transfer addition process (Scheme 1) must be present, at least partially, in a lower oxidation state, or activator state, Mₜⁿ/Ligand. However, typically, the lower oxidation state of the transition metal catalyst, particularly a more active catalyst is readily oxidized. Therefore, there are inherent difficulties in handling the catalyst associated with ATRP in large scale bulk and solution based polymerization processes and in emulsion and mini-emulsion processes where trace levels of oxygen should be removed. The typical ratio of activator (Mₜⁿ/Ligand) to deactivator (X-Mₜⁿ⁺¹/Ligand) varies with the specific monomers and the polarity of the reaction medium, as well as other factors, between 99 parts activator to 1 part deactivator to 5 parts activator to 95 parts deactivator.

To function as an ATRP transition metal catalyst, the transition metal must have at least two readily accessible oxidation states separated by one electron, a higher oxidation state and a lower oxidation state. The reversible redox reaction results in the transition metal catalyst cycling between the higher oxidation state (the “deactivator state”) and a lower oxidation state (the “activator state”) while the polymer chains cycle between having propagating chain ends and dormant chain ends. Typically, the transition metal is one of copper, iron, rhodium, nickel, cobalt, palladium, molybdenum, manganese, rhenium, or ruthenium. In some embodiments, the transition metal catalyst comprises a copper halide, and preferably the copper halide is one of Cu(I)Br or Cu(I)Cl. Living/controlled polymerizations typically, but not necessarily, comprise a relatively low stationary concentration of polymers comprising propagating chain ends in relation to polymers having dormant chain ends. When the polymer has a dormant chain end, the chain end comprises the transferable atom or group. The dormant chain end may be converted to a propagating chain end by transfer of the transferable atom or group to the transition metal catalyst in a lower oxidation state.

The description of the mechanism of an ATRP is provided for explanation and is not intended to limit the invention. The disclosed mechanism is generally accepted, but different transition metal catalyst complexes may result in different mechanisms. The ligand affects the structure of the catalyst, the solubility and activity of the catalyst. See Catalyst Development www.chem.cmuedu/groups/maty/about/research/05.html, hereby incorporated by reference.

Any transition metal complex capable of maintaining the dynamic equilibrium between kₐ and k_{deact}, and participating in a redox reaction with a compound comprising the transferable atom or group (“ATRP initiator”) may be used as the catalyst in ATRP. Many examples are discussed in the cited and hereby incorporated art. A suitable equilibrium can be formed after consideration of oxidation states, complex formation with suitable ligands and redox potential of the resulting complex to provide a catalyst for the desired (co)polymerization of a wide range of comonomers. A wide variety of ligands have been developed to prepare transition metal catalyst complexes that display differing solubility, stability and activity. The low concentration of active species reduces the probability of bimolecular termination reactions, leading to radical based polymerization processes that behave as a “living” system. In order to control molecular weight and molecular weight distribution there should be quantitative fast initiation with the rate of initiation, (Rᵢ), at least as fast as the rate of propagation (Rₚ), (Rᵢ<<Rₚ to Rᵢ˜Rₚ thereby controlling DPₙ (̂[M]/[I]₀) where [M] is the moles of monomer polymerized and [I]₀) is the initial concentration of the added initiator). However since such controlled CRP processes are apparently radical based polymerization processes some degree of termination reactions are unavoidable. In all radical polymerizations, biradical termination (kₜ) occurs with a rate which is dependent on the concentration of radicals ([P*]) to the power two, (Rₜ=kₜ[P*]²). Therefore, at the same rate of polymerization (the same concentration of active radicals), essentially the same number of chains would be expected to terminate, regardless if a conventional RP or a CRP system had been employed. This ignores to some degree the diffusion effect of macro-radicals since in a RP most chains are terminated by the reaction of the growing polymer radical with a newly generated small radical while in the case of a CRP all polymeric radicals in the system grow at the same rate as the reaction progresses and the only small molecules that can react with the polymeric radicals are monomers or the transition metal complexes in the deactivator state. However early in the typical batch CRP reaction lower molecular weight oligo-radicals do terminate and in the case of SFRP, or ATRP, these initial termination reactions push the equilibrium to the left hand side, (increasing k_{deact}) as a consequence of forming an excess of deactivator species, as a result of the persistent radical effect, [Fischer, H. Chem. Rev. 2001, 101, 3581-3610] and consequently addition of some deactivator prior to initiation of the reaction reduces such termination reactions.

The net result is that in conventional process, all chains are continuously terminated, whereas in CRP, as a result of the greater number of growing chains, the terminated chains constitute only small fraction of all chains (˜1 to 10%). The remaining species are dormant species, capable of reactivation, functionalization, chain extension to form block copolymers, etc. Thus CRP behaves as a “living” system. [Greszta, D. et. al. Macromolecules 1994, 27, 638.]

Additionally, relatively fast initiation, at least as fast as propagation, provides control over molecular weight (DPₙ=Δ[M]/[I]₀; i.e. the degree of polymerization is defined by the ratio of concentrations of the consumed monomer to the introduced initiator) and narrow molecular weight distribution. As used herein, “polymer” refers to a macromolecule formed by the chemical union of monomers, typically five or more monomers. The term polymer includes homopolymers and copolymers including random copolymers, statistical copolymers, alternating copolymers, gradient copolymers, periodic copolymers, telechelic polymers and polymers of any topology including block copolymers, graft polymers, star polymers, bottle-brush copolymers, comb polymers, branched or hyperbranched polymers, crosslinked polymers and such polymers tethered to particle surfaces or flat surfaces as well as other polymer structures.

As noted above, ATRP is the most frequently used CRP technique with a significant commercial potential for many specialty materials including coatings, sealants, adhesives, dispersants but also materials for health and beauty products, electronics and biomedical applications. [Matyjaszewski, K.; Spanswick, J. Materials Today 2005, 8, 26-33.] The most frequently used ATRP procedure is based on a simple reversible halogen atom transfer catalyzed by redox active transition metal compounds, most frequently copper. ATRP has been thoroughly described in a series of co-assigned U.S. patents and applications, such as U.S. Pat. Nos. 5,763,548; 5,807,937; 5,789,487; 5,945,491; 6,111,022; 6,121,371; 6,124,411; 6,162,882; 6,407,187; 6,512,060; 6,538,091; 6,541,580; 6,624,262; 6,624,263; 6,627,314; 6,759,491; and U.S. patent application Ser. Nos. 09/534,827; 09/972,056; 10/034,908; 10/269,556; 10/289,545; 10/638,584; 10/860,807; 10/684,137; 10/781,061 and 10/992,249 all of which are herein incorporated by reference, at least for the general discussion of initiators, monomers, and catalyst complexes described in these references. ATRP has also been discussed in numerous publications with Matyjaszewski as co-author and reviewed in several book chapters. [ACS Symp. Ser., 1998, 685; ACS Symp. Ser., 2000; 768; Chem. Rev. 2001, 101, 2921-2990; ACS Symp. Ser., 2003; 854; ACS Symp. Ser., 2006; 937.] Within these publications similar polymerization procedures may be referred to by different names, such as transition metal mediated polymerization or atom transfer polymerization, but the processes are similar and referred to herein as “ATRP”.

Certain advantages of an ATRP are as follows; many commercially available initiators may be used and various macroinitiators, including wafers, inorganic colloids, glass, paper, and bio-active molecules, including proteins, DNA, carbohydrates. Many commercially available polymers may be incorporated into an ATRP process through the inherent presence or addition of the ATRP initiating species in the first polymer. Many polymers produced by ATRP allow facile functionalization or transformation of the end groups by replacing terminal halogens with azides, amines, phosphines and other functionalities via nucleophilic substitution, radical addition or other radical combination reactions through post polymerization reactions thereby providing functional polymeric materials or composites, for example, specific applications as noted in the above references. Further an abundance of polymerizable monomers and macromonomers are available. This allows production of macromolecules with complex topology such as stars, combs and dendrimers, coupled with the ability to control composition and hence functionality in block, gradient, periodic copolymers etc. and even control polymer tacticity. The procedure is a simple procedure which may be carried out in bulk, or in the presence of organic solvents or in water under homogeneous or heterogeneous conditions, in ionic liquids, and in supercritical CO₂.

However, for certain applications, the concentration of the transition metal catalyst in an ATRP polymerization medium may have to be reduced in the final product. As such, there have been several methods developed to remove or reduce the amount of transition metals in the process, but these procedures add additional cost to the preparation of polymers by ATRP. The methods used to reduce the concentration of catalysts in the final product include: development of more active catalysts, for example CuBr complexed by Me₆TREN is ˜10,000 more active than catalysts complexed by bipyridine ligands; catalysts have been immobilized on solids leading to development of hybrid catalyst systems comprising both immobilized catalyst complexes interacting with small concentrations of soluble catalysts (˜10-20 ppm). There are also several methods developed to recover and regenerate catalysts, including separating the catalyst by filtration, adsorption, precipitation or extraction. For example, CuBr/PMDETA complex may be oxidized to Cu(II) species by exposure to air and quantitatively extracted from toluene to water, resulting, in some cases, with as little as <1 ppm of catalyst remaining in the polymer. However these steps add marginal cost. Therefore in spite of these advances there remains a need to reduce the concentration of catalyst in the active polymerization media while maintaining polymer reaction rate and retaining control over MW, PDI and functionality.

The most attractive route may be simply to decrease of the amount of the catalyst in the system, providing that the catalyst complex has sufficient reactivity and conditions are selected that allow retention of activity throughout the polymerization. Previously reported CuBr/Me₆TREN complexes not only allowed ATRP to be carried out at room temperature but also with much smaller amounts of the copper, since they are ˜10,000 times more active than originally used CuBr/bpy complexes. Regrettably, however one cannot just reduce the amount of Cu(I) 10,000 fold because as noted above termination reactions irreversibly consume the activators by converting them to the deactivator state, and with certain monomers the reactions usually slow down or stop, if the amount of Cu(I) initially present in the reaction is below 10 mole % of the initiator (as, 1˜10% of chains are terminated).

The amount of terminated chains depends on the concentration of propagating radicals, P*, and rate constant of termination, kₜ, according to equation 1, which describes the number of terminated chains (or loss of Cu(I) activator) in an atom transfer radical polymerization.

−Δ[Cu^{I}]=Δ[Pₜ]=kₜ[P*]²t (1)

However a detailed inspection of the ATRP rate law (Equation 2), indicates that the polymerization rate depends only on the ratio of Cu(I) to X—Cu(II) concentration but does NOT depend on the absolute concentration of copper complexes! Thus, in principle, one can reduce the amount of copper without affecting polymerization rate.

$${R}_{p} = {k}_{p} [ M ] [ {P}^{*} ] = {k}_{p} [ M ] {{K}_{eq} [ I ]}_{o} \frac{[ {Cu}^{I} ]}{[ X - {Cu}^{II} ]} \qquad ( 2 )$$

Unfortunately, as the reaction progresses due to termination reactions, Cu(I) is constantly converted to X-Cu(II) species and reaction rate decreases, according to persistent radical effect, and eventually, in the absence of a sufficient concentration of the activator complex ATRP stops. Therefore, the amount of copper catalyst complex that has generally been added to an ATRP reaction has exceeded that of the expected number of terminated chains (i.e. >10% [I]ₒ) in order to drive the reaction to completion at an acceptable rate. The true rate of termination is important, since as detailed later, this is the mole fraction of reducing agents, or free radical initiators that have to be added to maintain an ATRP reaction.

While we have focused on the concentration of activator a certain amount of the deactivation species (i.e. X—Cu(II)) is also needed in the system for a well-controlled polymerization because molecular weight distribution and final molecular weight depend on the ratio of propagation and deactivation rate constants and concentration of deactivator, according to Equation 3. (Where p is the degree of conversion.)

$$\frac{{M}_{w}}{{M}_{n}} = 1 + \frac{1}{{DP}_{n}} + ( \frac{{[ R - X ]}_{o} {k}_{p}}{{k}_{da} [ X - {Cu}^{II} ]} ) ( \frac{2}{p} - 1 ) \qquad ( 3 )$$

This would seem to present an impasse.

However in commonly assigned patent application PCT/US05/007265 a method to resolve this dilemma was disclosed. Embodiments of the polymerization process of the disclosed invention were directed to polymerizing free radically copolymerizable monomers in the presence of a polymerization medium initially comprising at least one transition metal catalyst, an atom transfer radical polymerization initiator and additionally comprising a reducing agent. The reducing agent may be added initially or during the polymerization process in a continuous or intermittent manner, forming a homogeneous reaction medium or a heterogeneous reaction medium. The polymerization process further comprised reacting the reducing agent with at least one of the transition metal catalyst in an oxidized state to form a compound that does not participate significantly in control of the polymerization process. The reducing agent was primarily used to reduce the transition metal complex in the oxidized state to the activator state and compensate for termination reactions thereby maintaining the rate of polymerization. This understanding allowed the overall concentration of transition metal in the polymerization medium to be reduced and comprised a molar ratio of the transition metal catalyst to the atom transfer radical polymerization initiator that could be less than 0.05 or even 0.02 mole compared to the added ATRP initiator. The novel procedure was called ARGET ATRP to express the idea that the activator for the ATRP reaction was regenerated by electron transfer.

To form a block copolymer by ATRP, a macroinitiator chain capped with a halogen (Pₙ—X) is activated by Cu^{I}—X/Ligand, and extended with monomer (M) (Scheme 1). One important condition to obtain a well-defined block copolymer is that the apparent rate of initiation should be greater than that of propagation. In other words, K_{ATRP}^{initiator}kᵢ>K_{ATRP}^{monomer}kₚ, where kᵢ and kₚ are the rate constants for initiation and propagation, respectively, and K_{ATRP}=k_{act}/k_{deact}. This ensures that all Pₙ—X chains begin growth within a narrow time frame, and a product with low polydispersity is obtained. There are, however, certain cases where this requirement is not met. The values of K_{ATP} for tertiary alkyl halides are generally larger than those for secondary alkyl halides. Consequently, there is poor initiation efficiency in the ATRP of methacrylate monomer from acrylate or styrene-based (macro)initiators (K_{ATRP}^{initiator}kᵢ<K_{ATRP}^{monomer}kₚ). At the beginning of such a block copolymerization a small fraction of acrylate or styrene macroinitiator terminal halogens are activated, methacrylate monomer is added, then the chain is deactivated again to be capped with a halogen. The resulting dormant chain is much easier to reactivate compared to the remaining unactivated polyacrylate or polystyrene macroinitiator. This leads to an inefficient extension of the macroinitiator, and a product with a bimodal distribution of molecular weights is obtained.

A procedure was developed to overcome poor initiation efficiency in a standard ATRP. The method, known as “halogen exchange”, utilizes a bromide terminated initiator used in conjunction with a CuCl based catalyst complex. Initiation of the R—Br bond occurs, followed by propagation with methacrylate, then deactivation with Cu^{II} catalyst to form R—Pₙ—Cl dormant chains. K_{ATRP} values for an R—Cl bond are smaller than those for an R—Br bond. So for this system, K_{ATRP}^{initiator}kᵢ≈K_{ATRP}^{monomer}kₚ, as initiators contain R—Br bond and reacted chains contain R—Cl bond. Therefore, a more equivalent amount of initiation will occur relative to propagation, resulting in improved initiation efficiency. Halogen exchange has been successfully applied to a number of systems where the addition of the second monomer would form a more active chain end than that present on the added (macro)initiator.

Recently, as noted above, a method has been developed for ATRP to be conducted with very low catalyst concentrations. This method, known as activators regenerated by electron transfer for ATRP (ARGET ATRP) has allowed polymerization to occur with as low as only a few ppm copper. In ATRP, termination reactions occur between growing chains that lead to the accumulation of Cu^{II} deactivator species. This is problematic in normal ATRP if low copper concentration is desired, as a large portion of the catalyst would become inactive. To overcome this, ARGET ATRP employs the use of an excess of reducing agent to continuously regenerate the Cu^{I} activators throughout the reaction (Scheme 2). It has been shown that ARGET is a successful polymerization method and can even improve the synthesis of high molecular weight polystyrene and poly(styrene-co-acrylonitrile) via ATRP. The benefit of low copper concentration makes ARGET a very attractive process for industrial applications, however it leads to some challenges. Because there is such a low amount of copper catalyst compared to the concentration of initiating sites, halogen exchange is not effective. Therefore, a new technique needed to be developed in order to have efficient cross propagation from polyacrylate and polystyrene macroinitiators to extend with methacrylates.

### SUMMARY OF THE INVENTION

The invention is directed to a polymerization process comprising polymerizing first radically polymerizable monomers with an ATRP initiator in a reaction medium comprising a transition metal catalyst and a reducing agent, wherein the polymerizing first radically polymerizable monomers forms an ATRP macroinitiator. After completion of the macroinitiator, the transition metal catalyst may be oxidized to the deactivator state to stop the further polymerization of first radically polymerizable monomers. The polymerization of second radically polymerizable monomers may be initiated by adding further reducing agent to convert the catalyst in the deactivator state to catalyst in the activator state. The further reducing agent may be the same or different than the reducing agent used in the polymerization to form the macroinitiator.

The polymerization process may comprise oxidizing the transition metal catalyst to the deactivator state after polymerization of the second radically polymerizable monomer to halt the polymerization at the desired conversion. Such a process may continue with further monomers to form the desired polymer, for example by initiating polymerization of third radically polymerizable monomers by adding further reducing agent to convert the catalyst in the deactivator state to catalyst in the activator state.

In embodiments, the transition metal catalyst is initially in a higher of two accessible oxidation states and the transition metal catalyst in a higher of two accessible oxidation states is reduced to a lower of the two accessible oxidation states by a redox reaction with a reducing agent. Any reducing agent capable of reducing the transition metal catalyst without adversely interfering with the polymerization process may be used, however, in certain embodiments, the reducing agent is only partially soluble in the reaction medium or even completely insoluble.

After the polymerizing one or more radically polymerizable monomers stops by oxidizing the transition metal catalyst, the process may optionally comprise removing any unreacted radically polymerizable monomers from the reaction medium.

It must be noted that, as used in this specification and the appended claims, the singular forms “a,” “and,” and “the” include plural referents unless the context clearly dictates otherwise. Thus, for example, reference to “a polymer” may include more than one polymer.

Unless otherwise indicated, all numbers expressing quantities of ingredients, time, temperatures, and so forth used in the present specification and claims are to be understood as being modified in all instances by the term “about.” Accordingly, unless indicated to the contrary, the numerical parameters set forth in the following specification and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, may inherently contain certain errors necessarily resulting from the standard deviation found in their respective testing measurements.

It is to be understood that this invention is not limited to specific compositions, components or process steps disclosed herein, as such may vary. It is also to be understood that the terminology used herein is for the purpose of describing particular embodiments only, and is not intended to be limiting.

### BRIEF DESCRIPTION OF THE FIGURES

The features and advantages of the present invention may be better understood by reference to the accompanying figures, in which:

FIG. 1 is a simplified process flow diagram for a plant showing the steps of the polymerization process;

FIG. 2 is a simplified process flow diagram for a plant showing the addition of a stream comprising the comonomer employed to conduct an efficient chain extension from a less active macroinitiator

FIGS. 3A, 3B, and 3C are kinetic plots of data gathered during embodiment of Run #WJ-04-07 which is an ARGET ATRP conducted with 50 ppm Cu and initial mole ratio of reagents nBA/DiBrIBE/Cu(II)/Me₆TREN/Sn(EH)₂=500/1/0.0025/0.1/0.1 at T=70° C., in the presence of 0.2 mole of anisole in where FIG. 3A is a graph of the ln([M]₀/[M]) versus time in minutes, FIG. 3B is a graph of the evolution of molecular weight and polydispersity versus conversion, and FIG. 3C is a graph of GPC data showing development of the molecular weight curves at various times; FIGS. 4A, 4B, and 4C are kinetic plots of data gathered during the embodiment of Run #WJ-04-08 an ARGET ATRP conducted with 50 ppm Cu and the macroinitiator formed in Run #WJ-04-07 conducted by addition of IBA, anisole and tin at 99% conversion of BA: ratio of reagents, IBA/PnBA/Cu(II)/Me₆TREN/Sn(EH)₂=+144/1/−/−/+0.1; anisole 3 equivalents vs IBA, T=70° C. where FIG. 4A is a graph of the ln([M]₀/[M]) versus time in minutes, FIG. 4B is a graph of the evolution of molecular weight and polydispersity versus conversion, and FIG. 4C is a graph of GPC data showing development of the molecular weight curves at various times FIGS. 5A, 5B, and 5C are kinetic plots of data gathered during the embodiment of Run #WJ-04-16 which is an ARGET ATRP conducted with 50 ppm Cu and initial mole ratio of reagents nBA/EtBrIB/Cu(II)/TPMA/Sn(EH)₂=156/1/0.0078/0.03/0.05; at T=60° C., with 0.2 mole of anisole where FIG. 5A is a graph of the ln([M]₀/[M]) versus time in minutes, FIG. 5B is a graph of the evolution of molecular weight and polydispersity versus conversion, and FIG. 5C is a graph of GPC data showing development of the molecular weight curves at various times;

FIGS. 6A, 6B, and 6C are the GPC traces of polymer samples taken during Runs described in Examples 2 and 3 which describes a continuous process for chain extension of an n-butyl acrylate macroinitiators prepared with different ligands with MMA;

FIGS. 7A, 7B, and 7C are kinetic plots of data gathered during the embodiment of Run #WJ-05-04 which is an ARGET ATRP of methyl methacrylate and styrene where FIG. 7A is a graph of the ln([M]₀/[M]) versus time in minutes, FIG. 7B is a graph of the evolution of molecular weight and polydispersity versus conversion, and FIG. 7C is a graph of GPC data showing development of the molecular weight curves at various times;

FIGS. 8A, 8B, and 8C are kinetic plots of data gathered during the embodiment of Run #WJ-05-06 which is a second embodiment of an ARGET ATRP of methyl methacrylate and styrene where FIG. 8A is a graph of the ln([M]₀/[M]) versus time in minutes, FIG. 8B is a graph of the evolution of molecular weight and polydispersity versus conversion, and FIG. 8C is a graph of GPC data showing development of the molecular weight curves at various times;

FIGS. 9A, and 9B are kinetic plots of data gathered during another embodiment of an ARGET ATRP of methyl methacrylate and styrene where FIG. 9A is a graph of the ln([M]₀/[M]) versus time in minutes, FIG. 9B is a graph of GPC data showing development of the molecular weight curves at various times;

FIGS. 10 and 10B are GPC traces comparing the chain extension of a poly(n-butyl acrylate macroinitiator comprising a number average molecular weight of 18,000 and a molecular weight distribution of 1.12 with methyl methacrylate, FIG. 10A, and with styrene and methyl methacrylate, FIG. 10B;

FIGS. 11A, 11B, and 12C are kinetic plots of data gathered comparing the ARGET ATRP embodiments comprising different solvents, anisole and DMF, where FIG. 11A is a graph of the ln([M]₀/[M]) versus time in minutes, FIG. 11B is a graph of the evolution of molecular weight and polydispersity versus conversion, and FIG. 11C is a graph of GPC data showing development of the molecular weight curves at various times;

FIGS. 12A and 12B are kinetic plots of data gathered comparing the ARGET ATRP embodiments comprising different concentrations of ascorbic acid where FIG. 12A is a graph of the ln([M]₀/[M]) versus time in minutes, FIG. 12B is a graph of the evolution of molecular weight and polydispersity versus conversion; and

FIG. 13 are GPC traces of the evolution of molecular weight over time for the block copolymerization of poly(methyl acrylate) (PMA) by ARGET ATRP using ascorbic acid as reducing agent.

### DESCRIPTION OF EMBODIMENTS OF THE INVENTION

The present invention is directed to a polymerization process for the production of block copolymers. Embodiments of the polymerization process comprise polymerizing radically (co)polymerizable monomers from an ATRP initiator in a reaction medium comprising a transition metal catalyst and a reducing agent. The ATRP process proceeds as long as at least a portion of the catalyst in present in the activator state. The deactivator state of the transition metal catalyst is formed from the normal initiation process of homolytic transfer of the radically transferable atom or group from the initiator or dormant polymer chain to the transition metal complex. The activator state of the transition metal catalyst, however, is typically reformed by the transfer of the radically transferable atom or group back to the growing radical end of the polymer chain. However, if radical termination reactions occur, there may be a buildup of the transition metal catalyst in the deactivator state. In order to counterbalance this buildup, a second mechanism may be involved to reform the transition metal catalyst in the activator state. To reform the activator, a reducing agent is added to the reaction medium to reduce the transition metal catalyst from the higher oxidation state to the lower oxidation state, or activator state, and maintain the rate of polymerization. This is shown in Scheme 2.

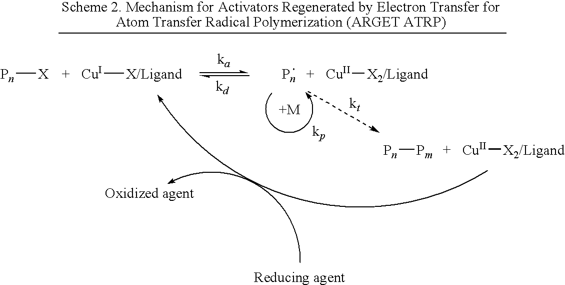

The presence of the reducing agent allows significantly lower concentrations of transition metal catalyst and allows significantly lower ratios of transition metal catalyst to ATRP initiator to be present in the reaction medium and still drive the reaction to completion. The molar ratio of the transition metal to the ATRP initiator may be less than 0.5, or less than 0.1, or even 0.05 or most preferably less than 0.01. Embodiments of processes of the invention may comprise a concentration of transition metal catalyst in the reaction medium of less than 1000 ppm, or even less than 100 ppm, and in certain embodiments, the concentration of transition metal catalyst in the reaction medium may be less than 50 ppm. The addition of a base, or excess ligand, to the reaction medium may assist in the reduction reaction and/or stabilization of the catalyst complex present at such low concentrations.

The transition metal catalyst may initially be in either the higher or the lower oxidation state. In the embodiment wherein the transition metal catalyst is in a higher of two accessible oxidation states the transition metal catalyst may be reduced or partially reduced to a lower oxidation state by a redox reaction with the reducing agent.

To be suitable as an ATRP transition metal catalyst, the transition metal must have at least two readily accessible oxidation states separated by one electron, a higher oxidation state and a lower oxidation state. The reversible redox reaction results in the transition metal catalyst cycling between the higher oxidation state (the “deactivator state”) and a lower oxidation state (the “activator state”) while the polymer chains cycle between having propagating chain ends and dormant chain ends. Typically, the transition metal is one of copper, iron, rhodium, nickel, cobalt, palladium, molybdenum, manganese, rhenium, or ruthenium. In some embodiments, the transition metal catalyst comprises a copper halide, and preferably the copper halide is one of Cu(I)Br or Cu(I)Cl. Living/controlled radical polymerizations typically, but not necessarily, comprise a relatively low stationary concentration of polymers comprising propagating chain ends in relation to polymers having dormant chain ends. When the polymer has a dormant chain end, the chain end comprises the transferable atom or group. The dormant chain end may be converted to a propagating chain end by transfer of the transferable atom or group to the transition metal catalyst. The description of the mechanism of an ATRP is provided for explanation and is not intended to limit the invention. The disclosed mechanism is generally accepted, but different transition metal catalyst complexes may result in different mechanisms. The ligand affects the structure of the catalyst, the solubilizing effect, and catalyst activity. See Catalyst Development www.chem.cmu.edu/groups/maty/about/research/05.html, hereby incorporated by reference. Suitable transition metals for transition metal catalysts of the invention include, but are not limited to, may be selected from the group consisting of Cu⁰, Cu¹⁺, Cu²⁺, Fe⁰, Fe²⁺, Fe.³⁺, Ru²⁺, Ru³⁺, Cr²⁺, Cr³⁺, Mo⁰, Mo⁺, Mo²⁺, Mo³⁺, W²⁺, W³⁺, Rh³⁺, Rh⁴⁺, Os²⁺, Os³⁺, Os⁴⁺, Ir⁺, Ir³⁺, Ir⁴⁺, Co⁺, Co²⁺, Re²⁺, Re³⁺, Ni⁰, Ni⁺, Mn³⁺, Mn⁴⁺, V²⁺, V³⁺, Zn⁺, Zn²⁺, Au⁺, Au²⁺, Ag⁺ and Ag²⁺.

Conversely, an ATRP process may be stopped by oxidation of the catalyst. There are several reasons why one may wish to stop a polymerization process. It may be desirable to stop the polymerization prior to high conversion of the monomer due to the increased possibility of side reactions that may affect the polydispersity or the molecular weight distribution of the polymer. In such a case, it may be desirable to stop the polymerization prior to the monomer conversion reaching 80%, or in some embodiments, prior to the monomer conversion reaching 70% to ensure sufficient concentration of active or living polymer chains are still present in the reaction medium. It is especially important to maintain active or living polymer chains for the production of block copolymers. If the chains are not active after the first polymerizations, the chains may not be easily used as macroinitiators in the second polymerization to form the block copolymer and the final product will comprise a combination of homopolymer and copolymer.

The polymerization process may be easily stopped by contacting the reaction medium with oxygen to oxidize the transition metal catalyst to the deactivator state. In an embodiment, air may be contacted with the reaction medium. In embodiments comprising an excess of reducing agent, the reducing agent may continue to reduce the oxidized transition metal catalyst until the reducing agent is finally consumed. Any oxidizing agent may be used to stop the polymerization process as long as the oxidation agent does not adversely affect the polymer or catalyst complex.

Therefore, an embodiment of the polymerization process includes polymerizing first radically polymerizable monomers to form an ATRP macroinitiator for use in preparation of a block copolymer. The polymerization of first radically polymerizable monomers is stopped by oxidizing the transition metal catalyst to the deactivator state. The polymerization may be stopped at any desired degree of polymerization, for example, the degree of polymerization desired to provide the desired properties to the block copolymer or to provide sufficient concentration of living polymer chains, for example. The reducing agent may be added to the reaction medium such that it is a concentration of about 10 times the concentration of transition metal catalyst, or from 1 to 200 times the concentration, or in certain applications, 5 to 20 times. In polymerizations that comprise fewer termination reactions, the concentration of reducing agent may be less than 5 times the concentration of transition metal catalyst. This may amount to 10% to 50% excess reducing agent needed to initiate the polymerization and reduce the effect of the termination reactions. Therefore, embodiments of the polymerization process may comprise adding an amount of reducing agent added is less than 10% greater than a molar amount of expected termination reactions, plus any reducing agent necessary to remove any oxidizing agent from the reaction medium and activate the catalyst and initiate the polymerization.

Embodiments of the polymerization process of the invention also include initiating polymerization of second radically polymerizable monomers from the ATRP macroinitiator prepared by the polymerization of the first radically polymerizable monomers. The second polymerization may be initiated by adding further reducing agent to convert a portion the oxidized catalyst in the deactivator state to transition metal catalyst in the activator state. The second radically polymerizable monomers may be added before, during, or after reduction of the catalyst.

Suitable monomers used in the polymerization step of the present invention comprise at least one diene group or at least one vinyl group. Examples include, but are not limited to, acrylate esters, (meth)acrylate esters, acrylonitriles, cyanoacrylate esters, maleate and fumarate diesters, vinyl halides, vinyl pyridines, vinyl N-alkylpyrroles, vinyl oxazoles, vinyl thiazoles, vinyl pyrimidines, vinyl imidazoles, vinyl ketones, acrylic acids, (meth)acrylic acids, styrenes, and derivatives of these monomers. Vinyl ketones include those in which the α-carbon atom of the alkyl group does not bear a hydrogen atom, such as vinyl ketones in which both α-carbons bear a C₁-C₄ alkyl group, halogen, etc. or a vinyl phenyl ketone in which the phenyl group may be substituted with from 1 to 5 C₁-C₆-alkyl groups and/or halogen atoms. Styrenes include those in which the vinyl group is substituted with a C₁-C₆ alkyl group, such as at the α-carbon atom, and/or those in which the phenyl group is substituted with from 1 to 5 substituents including a C₁-C₆ alkyl, alkenyl (including vinyl), allynyl (including acetylenyl), or phenyl group, and functional groups such as C₁-C₆ alkoxy, halogen, nitro, carboxy, C₁-C₆ alkoxycarbonyl, hydroxy (including those protected with a C₁-C₆ acyl group), and cyano groups. Specific examples include esters of acrylic acid, such as acrylate esters of C₁-C₂₀ alcohols, (meth)acrylate esters of C₁-C₂₀ alcohols, methyl acrylate (MA), methyl methacrylate (MMA), butyl acrylate (BA), t-butyl acrylate, t-butyl (meth)acrylate, 2-ethylhexyl acrylate (EHA), acrylonitrile (AN), methacrylonitrile, styrene, DMAEMA, acrylamide, acrylonitrile, methacrylonitrile, vinyl pyridine and derivatives thereof. The term “alkyl” as used herein refers to a branched or unbranched saturated hydrocarbon group generally comprising 1 to 24 carbon atoms, such as methyl, ethyl, n-propyl, isopropyl, n-butyl, isobutyl, t-butyl, octyl, decyl, tetradecyl, hexadecyl, eicosyl, tetracosyl and the like, as well as cycloalkyl groups such as cyclopentyl, cyclohexyl and the like.

In some embodiments, the copolymerization rate of the radically polymerizable monomer in the second block of the block copolymer is significantly higher than the initiation rate of the macroinitiator. In such an embodiment, it may be more difficult to obtain block copolymers with a low polydispersity in the second block. The initiation rate of the macroinitiator will be slow as compared to the polymerization rate of the second monomer(s) resulting in the chain extension of the first fraction of activated chains while most chains are not yet initiated.

Embodiments of the polymerization process also comprise oxidizing the transition metal catalyst to the deactivator state after polymerization of the second radically polymerizable monomer and, optionally, initiating polymerization of third radically polymerizable monomers by adding further reducing agent to convert the catalyst in the deactivator state to catalyst in the activator state. The second radically polymerizable monomers may act as a transition block to allow efficient initiation of the polymerization of the third radically polymerizable monomers from the macroinitiator. It may be desirable to limit the degree of polymerization of the second radically polymerizable monomers so that the transition block does not significantly affect the properties of the final block copolymer but primarily acts as a transition block that allows for efficient initiation of the macroinitiator and, thereby, allows the formation of block copolymers with low polydispersities in each block. Embodiments of the polymerization process comprise polymerizing second radically polymerizable monomers into a transition block intermediate of two other blocks wherein the degree of polymerization of the transition block is less than 20, or in some application the degree of polymerization of the monomer in the transition block is less than 10.

The transition block may also be a gradient block of first radically polymerizable monomers or third radically polymerizable monomers and the second radically polymerizable monomers. Certain initiators or macroinitiators are not efficient initiators for certain other radically polymerizable monomers. If a gradient transition block is provided, the efficiency of the macroinitiator may be improved to provide a controlled polymerization process wherein the molecular weight is substantially the same as the theoretical molecular and the molecular weight distribution is less than 2.0, or more preferably less than 1.5. The second radically polymerizable monomer may be added simultaneously with the third radically polymerizable monomers or at the end of the polymerization of the first radically polymerizable monomers prior to addition of the oxidizing agent. On such a case, the block copolymer may comprise one, two or more blocks comprising predominantly one monomer or one, two or more blocks may be a gradient copolymer such as ABA, ABCBA, and star polymers, for example.

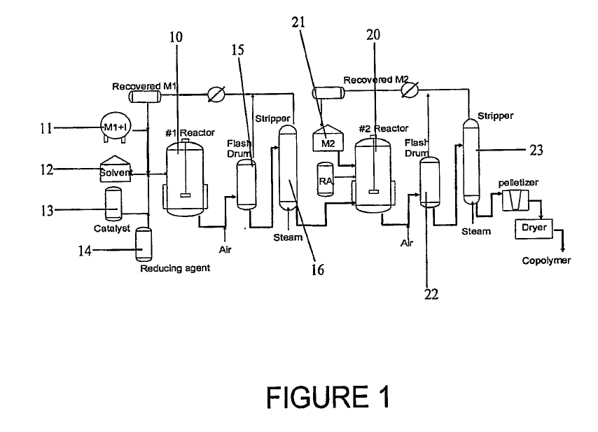

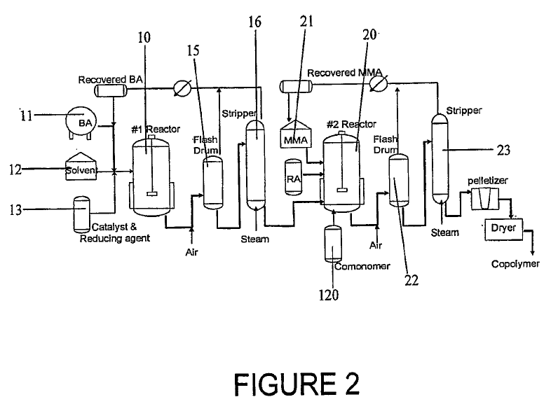

There is no limit to the number of blocks including transition blocks that may be included in embodiments of the polymerization process of the invention since linear, branched or star block copolymers may be prepared. The transition metal catalyst may be oxidized and reduced any number of times. The polymerization process may include removing any unreacted monomer from the reaction medium prior to adding a different monomer for preparation of a block copolymer that does not comprise the first monomer(s) in the second block(s). If the monomers are removed prior to initiation of the second block, a more distinct block copolymer may be formed. The monomer may be removed by distillation or vacuum distillation, for example this can be conducted in the first reactor or as shown schematically in FIGS. 1 and 2 the first monomer(s) are removed in a flash drum followed by a stripper such as a stranding devolatilizer.

In both embodiments shown in FIGS. 1 and 2, heat is added to the stripper by steam, however other methods of heating the polymer may be utilized. (The steam may not be added directly to the polymer but to a jacket or other heat exchange configuration.) Other commercially available industrial process for removal of low levels of monomer form a polymer can be employed as the first macroinitiator is transferred to the second stage, such as a devolatilizing extruder. The stripping equipment may also be used to remove any excess oxidizing agent used to stop the previous polymerization. Therefore, embodiments of the polymerization process comprise removing excess oxidation agents from the reaction medium.

Embodiments of the polymerization process of the present invention are directed to sequential polymerization of radically (co)polymerizable monomers in the presence of a polymerization medium comprising at least one transition metal catalyst, an ATRP initiator and additionally comprising a reducing agent. Each sequential polymerization process may further comprise reaction of the reducing agent with at least one of the transition metal catalyst in an oxidized state and a compound comprising a radically transferable atom or group to form a compound that does not participate significantly in control of the polymerization process. In certain embodiments, the compound that does not participate significantly in control of the polymerization process, for example, does not comprise a radically transferable atom or group that can participate in a controlled polymerization process.

In the present invention, the reducing agent may reduce the transition metal complex in an oxidized state to form a transition metal catalyst in the activator state in a substantially non-reversible reaction. AGET ATRP may comprise one method for forming a catalyst in the activator state from a stable catalyst precursor or catalyst in the deactivation state in an essentially non-radical forming reaction. The transition metal catalyst in the reduced activator state may then participate in a reversible redox reaction with an ATRP initiator to form the propagating active polymer chain. The reducing agent may also react directly with the ATRP initiator to form the propagating active polymer chain in a substantially nonreversible electron transfer reaction: In such a case, a transition metal complex in the higher oxidation state may react with the propagating active polymer chain to form a dormant polymer chain and the transition metal catalyst in the lower oxidation state by a reversible redox reaction. In certain embodiments, the reducing agent may be a transition metal in the zero oxidation style or a standard free radical initiator, in these cases, the reducing agent may not be considered a “halogen trap” as the transition metal in the zero oxidation state forms additional activator and the standard free radical initiator can form additional initiating species.

As stated above, as a “standard” ATRP progresses to high monomer conversion, chain end functionality may decrease due to bimolecular terminations reactions. [Lutz, J.-F.; Matyjaszewski, K. Macromolecular Chemistry and Physics 2002, 203, 1385-1395; Lutz, J.-F.; Matyjaszewski, K. Journal of Polymer Science, Part A: Polymer Chemistry 2005, 43, 897-910.] The mechanism of this phenomenon may include β-H elimination reactions induced by the copper(II) deactivator. These elimination reactions, which occurred later in the reaction, did not significantly affect the polymer molecular weights and the polydispersity. Therefore, a linear evolution of the molecular weight and low-polydispersity polymers were still observed despite a loss of functionality. Understanding these side reactions helps in the selection of the proper conditions for reducing the contribution of the elimination process to loss of terminal functionality. That is, if one desired to prepare a block copolymer the preparation of the first block macroinitiator should be stopped at lower than 80% conversion of the first comonomers in order to retain chain-end functionality and prepare a high purity block copolymer.

In embodiments with low concentrations of transition metal catalysts the occurrence of transition metal induced β-H elimination reactions should also be reduced; i.e. β-H elimination induced by the copper^{(II)} deactivator should be reduced since the concentration of transition metal is reduced by a factor of 100 or more. Therefore, one embodiment of the process allows the polymerization process to go to higher conversion while retaining terminal functionality and/or proceed to prepare polymers of higher molecular weight while retaining terminal functionality and living properties. [Jakubowski, W.; Min, K.; Matyjaszewski, K. Macromolecules 2006, 39, 3945. and Matyjaszewski, K.; Jakubowski, W.; Min, K.; Tang, W.; Huang, J.; Braunecker, W. A.; Tsarevsky, N. V. Proceedings of the National Academy of Sciences of the United States of America 2006, 103, 15309-15314.]

A continuous process to prepare block copolymers was developed and disclosed in U.S. patent application Ser. No. 10/788,995 where the second monomers were added to the copolymerization when less than 90% of the first comonomers had polymerized. This allowed preparation of block copolymers where there was a gradient incorporation of the first comonomers into the block comprising the second comonomers. This procedure therefore does not prepare “pure” block copolymers where the composition of each segment is predominantly one monomer. Further as shown below in one example while this procedure does work for ARGET block copolymer chain extension for certain monomers the molecular weight distribution of the second block(s) are not as narrow as may be desired for some applications. Therefore, there is a need to develop a simple scaleable process for the preparation of block copolymers employing ATRP for the preparation of each segment wherein the composition and molecular weight distribution of each segment are known and controlled to the desired degree.

FIG. 1 is a simplified process flow diagram for a two stage polymerization process for the preparation of a block copolymer utilizing ARGET ATRP in each stage of the process. Though the process flow diagram shows two reactors and sequential process steps between the reactors 10 and 20, the process may be conducted in a single reactor with each step sequentially conducted in the single reactor. In this embodiment, to simplify the figure, monomer and initiator are added individually and stored in a railcar 11 and pumped together into #1 reactor 10, optionally, solvent may be stored and pumped to the reactor 10 from storage 12, and catalyst in the higher oxidation state are added from storage tank 13 sequentially to #1 reactor 10 and stirred to form a reaction medium, the catalyst is activated by addition of the reducing agent from the storage tank 14. This activation reaction can also be employed to remove small amounts of oxygen present in the #1 reactor 10. Any oxygen present in the reaction medium may oxidize the transition metal catalyst to the deactivator state; however, the reducing agent may then re-reduce the transition metal catalyst to an activator state. The reduced catalyst complex may then activate the ATRP initiator and start the controlled polymerization process. When monomer conversion has reached the desired level of conversion the catalyst complex may be deactivated by addition of a sufficient amount of air or other oxidizing agent injected into the reaction medium as it is transferred to the flash drum 15. The air converts all the transition metal catalyst in the activator state to the stable higher oxidation state complex. Optionally, the air may be added directly into the #1 reactor 10 or, as shown in FIG. 1, during the transfer from the #1 reactor 10 to the flash drum 15. Most or all of the unreacted monomer form #1 reactor 10 is removed in the flash drum 15 and stripper 16. The recovered unreacted monomers are removed from the reaction medium comprising the ATRP macroinitiator and the transition metal catalyst in the deactivator state and may be recycled for use in #1 reactor 10. The reaction medium may then be transferred to #2 reactor 20. The second radically polymerizable monomer may be added from storage tank 21 to #2 reactor 20. Additional reducing agent may be added to reactivate the transition metal catalyst and initiate polymerization of a second block thereby forming a block copolymer.

After the desired conversion of the second monomer(s) the catalyst complex is again deactivated by oxidation with air and monomer(s) and solvent, if present, are removed in flash drum 22 and stripper 23 providing the pure solid block copolymer.

When air is injected into the process stream as the effluent from the #1 reactor is pumped into the flash drum 15, the oxygen present in the air oxidizes the low concentration of catalyst to the higher oxidation state thereby terminating the polymerization reaction. This allows some or all of the residual monomer present in the polymerization mixture to be removed from the first polymer while the dormant catalyst complex remains in the polymer stream to be reactivated for the second polymerization step.

Not shown in this simplified process flow diagram of FIG. 1 is any optional equipment required to remove the ppm levels of catalyst after the second deactivation prior to the flash drum 22 by any process known to one skilled in the art if desired or required. In one embodiment of the polymerization process, catalyst removal is not required since the catalyst level is sufficiently low that the formed block polymer is colorless. The embodiment shown in FIG. 1 does not include an operating unit for adding a third reducing agent at the end of an ATRP process to activate a transition metal catalyst complex in the higher oxidation state to allow post-polymerizations reactions including coupling reactions or “click” functionalization reactions.

FIG. 2 is a simplified process flow diagram for a polymerization process for the preparation of a block copolymer utilizing ARGET ATRP in each stage of the process similar to the process of FIG. 1. In the embodiment of FIG. 2, however, second radically polymerizable comonomers may be added to the reaction medium from storage tank 120 to form a transition block or gradient copolymer to provide efficient initiation from the macroinitiator prepared with first radically polymerizable monomers, in this embodiment is exemplified in the examples by the addition of butyl acrylate or styrene, from storage tank 11. The second radically polymerizable monomers may be added prior to the addition of the third radically polymerizable monomers, in this embodiment methyl methacrylate, from storage tank 21 or simultaneously to such monomers. The second radically polymerizable comonomers are selected to provide a dormant chain end that is activated at a similar rate to the dormant chain end on the first pure macroinitiator, poly(butyl acrylate) prepared in #1 reactor 10 thereby reducing the rate of subsequent activation steps and ensuring slower propagation of the second block. The second radically polymerizable comonomer is added at an amount that allows efficient chain extension and formation of a segmented copolymer wherein a majority of the first macroinitiator is incorporated into a segmented copolymer. The second monomer may be selected to form a copolymer with the third monomer that undergoes phase separation from the first polymer block. In a further embodiment, the amount of second radically polymerizable comonomers added to the #2 reactor 20 is sufficient to allow chain extension but also allow all the second radically polymerizable comonomers to be incorporated into the segmented copolymer. The second monomer may be selected to form a copolymer with the third monomer that undergoes phase separation from the first polymer block. The remaining monomer, methyl methacrylate, separated in flash drum 22 and stripper 23 may then be recycled to storage tank 21. If second radically polymerizable monomers remain at the desired level of conversion for the second block(s) then the monomers separated in flash drum 22 and stripper 23 may then be recycled to a separate storage tank or directly to reactor #2.

Embodiments of the polymerization process of present invention therefore include bulk polymerization processes, polymerization processes performed in a solvent, emulsion polymerization processes, mini-emulsion polymerization processes, microemulsion processes, reverse emulsion polymerization processes, suspension polymerization processes and processes conducted with supported catalyst complexes. In such processes, the biphasic polymerization processes may further comprise at least one of a suspending medium, a surfactant, and a monomer phase comprising at least a portion of the radically polymerizable monomers.

### EXAMPLES AND DISCUSSION OF EXAMPLES

### Example 1

### Production of Poly(Isobornyl Acrylate-b-n-butyl Actrylate-b-isobornyl Acrylate)

A continuous process for the preparation of an ABA block copolymer with block copolymer segments comprising predominantly one monomer. (See Runs #WJ-04-07 and WJ-04-08).

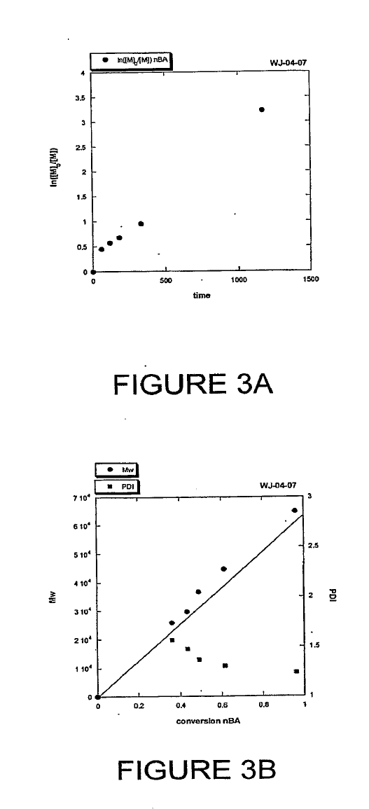

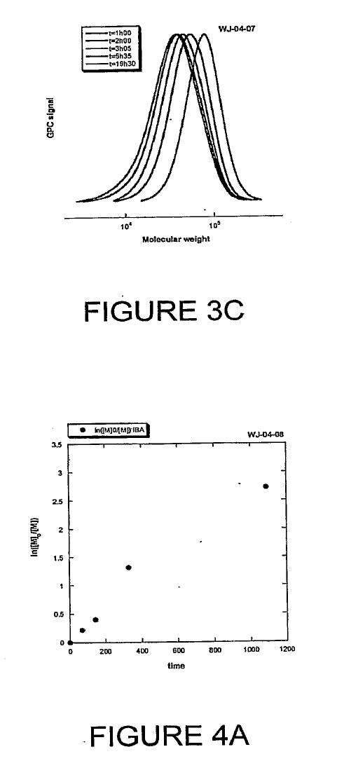

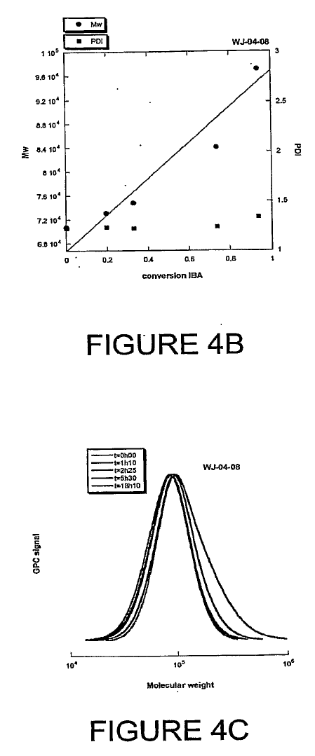

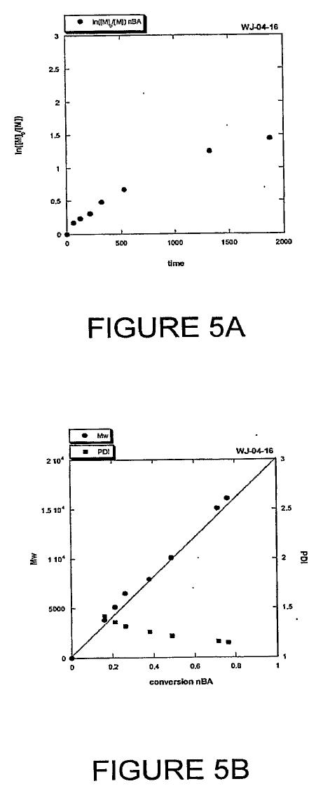

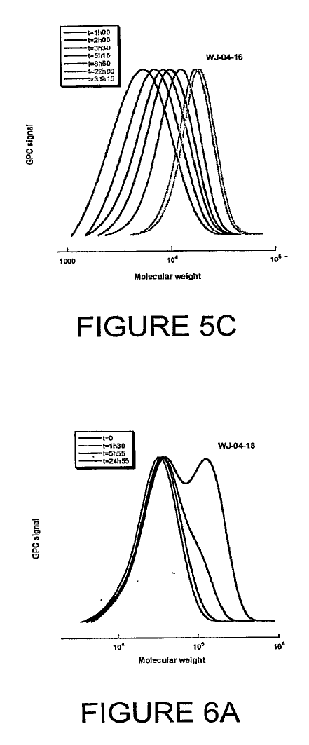

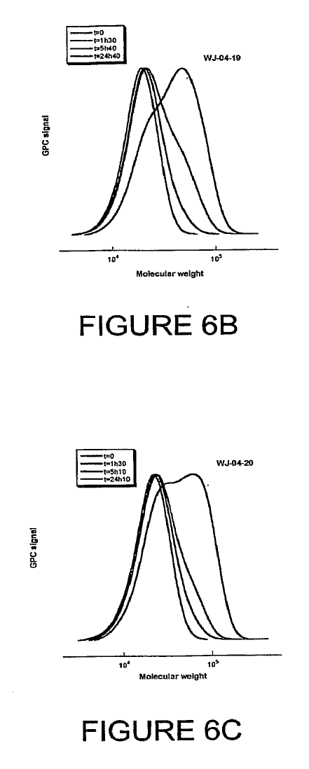

In the first stage (Run #WJ-04-07) an ARGET ATRP of nBA was conducted using a difunctional initiator, 1,2-bis(bromoisobutyryloxy) ethane (DiBrIBE), and a ratio of butyl acrylate/initiator/copper^{(II)}chloride/ligand/tin^{(II)} 2-ethylhexanoate, (BA/DiBrIBE/Cu(II)/Me₆TREN/Sn(EH)₂), equal to 500/1/0.025(50 ppm)/0.1/0.1. The polymerization process was carried out in anisole at 0.2 volume equivalents vs. monomer at 70° C. to form a difunctional macroinitiator, the B block, required for the preparation of an ABA block copolymer. All the conditions and results are shown in Table 1 and compared to the results of a normal ATRP (Table 1 Run #WJ-03-83). FIGS. 3A-3C are kinetic graphs of the polymerization process and show the regular increase in conversion with time (FIG. 3A), the increase in molecular weight with conversion (FIG. 3B), and the GPC traces for samples periodically taken from Run # WJ-04-07 (FIG. 3C). FIGS. 3A-3C show a smooth increase in molecular weight with conversion with no evidence of termination or low molecular weight impurities. As can be seen, polymerization proceeded with first-order kinetics and there was a linear increase in molecular weight with conversion and the molecular weight of the final polymer was close to the theoretical value.

| Name of | | Mw | Mw | Conv. | |
|---|---|---|---|---|---|
| sample | time | (GPC) | theor. | nBA | PDI |
| WJ-04-07 | 0 | 0 | 0 | 0 | 0 |
| | 60 | 25800 | 22800 | 0.36 | 1.57 |
| | 120 | 29600 | 27400 | 0.43 | 1.48 |
| | 185 | 36700 | 30800 | 0.49 | 1.37 |
| | 335 | 44600 | 38600 | 0.61 | 1.31 |
| | 1170 | 64900 | 60500 | 0.96 | 1.24 |

TABLE 1
Conditions and results for normal and an ARGET ATRP process of nBA using difunctional initiator
dimethyl 2,6-dibromoheptanedioate (DMDHD) or 1,2-bis(bromoisobutyryloxy) ethane (DiBrIBE)
and extension with isobornyl acrylate (IBA)

| | | | | | Time | Conv. | | | |
|---|---|---|---|---|---|---|---|---|---|
| Run # | In | Cu(I) | Cu(II) | ligand | (min) | (%) | M_{n,theo}^{f} | M_{n,GPC} | M_{w}/Mₙ |
| WJ-03-83^{a} | 1 | 2 | — | 1.6 | 1720 | 0.84 | 50500 | 40700 | 1.09 |
| | DMDHD | (4000 ppm) | | PMDETA | | | | | |
| WJ-03-100^{b} | 1 | — | 0.025 | 0.1 | 1170 | 0.97 | 61000 | 58300 | 1.28 |
| (by WJ) | DiBrIBE | | (50 ppm) | Me₆TREN | | | | | |
| WJ-04-07^{b} | 1 | — | 0.025 | 0.1 | 1170 | 0.96 | 60500 | 64900 | 1.24 |
| | DiBrIBE | | (50 ppm) | Me₆TREN | | | | | |
| WJ-04-08^{c} | 1 | — | — | — | 330 | 0.73 | 88800 | 84100 | 1.24 |
| | PnBA | | | Me₆TREN | | | | | |

^{a}Cu(I) = CuBr; ligand = PMDETA; [nBA]₀/[In]₀ = 470; [nBA]₀ = 5.19 M; T = 50° C., in anisole/acetone (0.05/0.25 volume equivalents vs. monomer);
^{b}In = 1,2-bis(bromoisobutyryloxy) ethane; Cu(II) = CuCl₂; [nBA]₀/[In]₀ = 500; [nBA]₀ = 5.83 M; T = 70° C., in anisole (0.2 volume equivalents vs. monomer);
^{c}In = Run # WJ-04-07; Cu(II) = CuCl₂; [IBA]₀/[In]₀ = 144; [IBA]₀ = _M; T = 70° C., in anisole (3 volume equivalents vs. monomer), +0.1 eq of Sn(EH)₂
^{f}M_{n,theo} = ([M]₀/[In]₀) × conversion

TABLE 2
Experimental conditions and properties of PnBA prepared by an ARGET ATRP process-effect of type of ligand^{a}

| | | Cu | | | | | Time | Conv. | | | |
|---|---|---|---|---|---|---|---|---|---|---|---|
| Run # | EtBrIB | [ppm] | CuCl₂ | ligand | AIBN | Sn(EH)₂ | (min) | (%) | M_{n,theo}^{b} | M_{n,GPC} | M_{w}/Mₙ |
| WJ-04-15 | 1 | 50 | 0.0078 | 0.03 | — | 0.05 | 1320 | 0.91 | 18200 | 21200 | 1.47 |
| | | | | Me₆TREN | | | | | | | |
| WJ-04-16 | 1 | 50 | 0.0078 | 0.03 | — | 0.05 | 1875 | 0.76 | 15200 | 16100 | 1.15 |
| | | | | TPMA | | | | | | | |
| WJ-04-17 | 1 | 50 | 0.0078 | 0.03 | — | 0.05 | 1815 | 0.82 | 16400 | 16200 | 1.25 |
| | | | | TPEDA | | | | | | | |

^{a}[nBA]₀/[EtBrIB]₀ = 156; [nBA]₀ = 5.84 M; T = 60° C., in anisole (0.2 volume equivalent vs. monomer);
^{b}M_{n,theo} = ([M]₀/[EtBrIB]₀) × conversion

TABLE 3
Experimental conditions and properties of PnBA-b-P(nBA-grad-MMA) prepared by an ARGET ATRP process.^{a}

| | | | | | | | Conv. MMA/ | | | |
|---|---|---|---|---|---|---|---|---|---|---|
| | | Cu | | | | Time | BA | | | |
| Run # | In | [ppm] | CuCl₂ | ligand | Sn(EH)₂ | (min) | (%) | M_{n,theo}^{b} | M_{n,GPC} | M_{w}/Mₙ |
| WJ-04-18 | 1 | — | — | — | +0.05 | 1495 | 0.92/0.64 | 31200 | 37200 | 2.17 |
| | (WJ-04-15) | | | Me₆TREN | | | | | | bimodal |
| WJ-04-19 | 1 | — | — | — | +0.05 | 1480 | 0.84/0.57 | 26200 | 30300 | 1.41 |
| | (WJ-04-16) | | | TPMA | | | | | | bimodal |
| WJ-04-20 | 1 | — | — | — | +0.05 | 1450 | 0.86/0.59 | 26400 | 30200 | 1.62 |
| | (WJ-04-17) | | | TPEDA | | | | | | bimodal |

^{a}[MMA]₀/[PnBA]₀ = 80; [MMA]₀ = 6.23 M; T = 60° C., in anisole (0.5 volume equivalent vs. monomer was added);
^{b}M_{n,theo} = ([M]₀/[EtBrIB]₀) × conversion.

The preparation of the mid-block in Run #WJ-04-07 was stopped after 20 h, at 96% conversion of nBA by opening the flask to air to oxidize the catalyst. Vacuum was applied to remove unreacted monomer and solvent. While these steps were conducted in a single flask, a similar process may be operated such as shown in FIG. 1 as occurring sequentially with the macroinitiator at this first stage prepared in #1 reactor 10 and the second polymerization process performed in #2 reactor 20 and the removal of the first monomer and solvent occurring in the flash tank and stripper as the macroinitiator was transferred from #1 reactor 10 to #2 reactor 20.

In order to conduct the chain extension reaction (Table 1 Run #WJ-04-08) a fresh portion of degassed anisole, isobornyl acrylate (IBA) and Sn(EH)₂ were then added sequentially to the Schlenk flask and the chain extension with IBA was conducted. The chain extension reaction formed an ABA block copolymer. As shown in FIGS. 4A-4C the reaction was successful, resulting in the production of the final PIBA-b-PnBA-b-PIBA triblock block copolymer exhibiting monomodal molecular weight distribution and the same low PDI (1.24) attained in the preparation of the first mid-block after 75% of the IBA had polymerized, as can be seen in FIG. 4B. There was a slight broadening of the molecular weight for the triblock copolymer as conversion was increased above 75% as can be seen in FIG. 4C. In many, indeed most, of the applications for a segmented block copolymer, this slight broadening of the molecular weight distribution of the copolymer will not significantly affect the properties of the phase separated material since the minimum molecular weight of the A block is above that required for phase separation and above the chain entanglement molecular weight. Note however that the reaction temperature was only 70° C. and the Tg of the A-block domains probably increased to greater than 70° C. as the reaction progressed beyond 75% conversion. Therefore, if desired, a narrow PDI block copolymer may be obtained by adding more solvent or running at a higher temperature or both, or by increasing the temperature as conversion of the second monomer increases.

TABLE 4

| Name of | | Mw | Mw | Conv. | |
|---|---|---|---|---|---|
| sample | time | (GPC) | theor. | MMA | PDI |
| WJ-04-08 | 0 | 70700 | 66800 | 0 | 1.23 |
| | 70 | 73100 | 72700 | 0.20 | 1.24 |
| | 145 | 74800 | 76700 | 0.33 | 1.23 |
| | 330 | 84100 | 88800 | 0.73 | 1.24 |
| | 1090 | 97100 | 94800 | 0.93 | 1.34 |

The conversion of the first radically polymerizable monomer for preparation of the macroinitiator was greater than 95% and that there was a clean chain extension after reactivation of the catalyst, with no trace of a low molecular weight tail in the GPC traces of FIG. 4C of the tri-block copolymers. Thereby indicating retention of chain end functionality during the multiple process steps of:

preparation of the macroinitiator;

termination of the polymerization by oxidation of the catalyst;

stripping of volatiles from the reaction medium;

addition of a second monomer,

addition of a second aliquot of solvent and

catalyst reactivation by adding a reducing agent.

The formed block copolymer is a thermoplastic elastomer.
This laboratory example therefore exemplifies the process depicted in FIG. 1 where the chain extension reaction involves removal of the first monomer(s) followed by chain extension with second monomer(s); where the rate of propagation of the second monomer(s) is comparable to the rate of cross propagation from the first block macroinitiator to the second block. The surprisingly higher level of chain end functionality at high conversion of the first monomer to polymer in these embodiments of the process may be a consequence of lower catalyst levels employed in this example than the prior art ATRP processes.

### Example 2

### ARGET ATRP of n-butyl Acrylate with Different Ligands

A series of ARGET ATRP's of n-butyl acrylate were conducted with different ligands. Me₆TREN, TPMA and TPEDA. (Runs #WJ-04-15, 16, 17). The ligands were selected to form strongly binding complexes with copper and therefore resist competitive binding reactions with monomer or other additives present in the reaction medium at much higher molar concentrations. The reactions conditions in all processes were kept constant: the ratio of BA/EtBrIB/Cu(II)/L/Sn(EH)₂ was 156/1/0.01(50 ppm)/0.03/0.05 and reactions were carried out in 0.2 volume equivalents of anisole vs. monomer at 60° C. The reaction conditions and results are shown in Table 2. It can be seen that the best control was achieved when TPMA was used as the ligand to form the catalyst complex. FIGS. 5A-5C show the reaction kinetics and GPC traces for samples periodically taken from Run #WJ-04-16, where TPMA was used as ligand, GPC traces were monomodal, molecular weight close to theoretical values and a low PDI=1.15 was observed (the lowest PDI with Me₆TREN was 1.25).

TABLE 5

| Name of | | Mw | Mw | Conv. | |
|---|---|---|---|---|---|
| sample | time | (GPC) | theor. | nBA | PDI |
| WJ-04-16 | 0 | 0 | 0 | 0 | 0 |
| | 60 | 3800 | 3137 | 0.16 | 1.42 |
| | 120 | 5100 | 4206 | 0.21 | 1.36 |
| | 210 | 6500 | 5243 | 0.26 | 1.32 |
| | 315 | 7900 | 7611 | 0.38 | 1.26 |
| | 530 | 10100 | 9775 | 0.49 | 1.22 |
| | 1320 | 15100 | 14300 | 0.71 | 1.16 |
| | 1875 | 16100 | 15200 | 0.76 | 1.15 |

The potential order for the reactivity of the tested ligands for ARGET ATRP were expected to be: TPMA>TPEDA>Me₆TREN> . . .

Although catalyst complexes formed with tri(2-pyridylmethyl)amine (TPMA) ligand are slightly less active than complexes formed with Me₆TREN, resulting in ARGET ATRP processes which are slower when TPMA is used rather than Me₆TREN, the reactions are better controlled, perhaps due to fact that TPMA binds stronger to Cu species which leads to a higher real concentration of complexed Cu^{II} species in the system.

### Example 3

### Poly (Butylarylate) Macroinitiator Preparation

Synthesis of PBA macroinitiator (target DPₙ=390, 50k) via ARGET ATRP with 50 ppm of copper (Run # WJ-04-33) (conditions: nBA/DiBrIBE/Cu(II)/TPMA/Sn(EH)₂=468/1/0.023/0.03/0.1; T=75° C., anisole 0.2 vol. equiv. vs. monomer) The same procedure as for Run # WJ-04-31. The final product was obtained with Mₙ=50700, PDI=1.08).

### Example 4

### Block Copolymer Preparation

Extension of PBA from Example 3 with MMA and BA via normal ATRP (Run #WJ-04-36, 36 wt % BA)-P(MMA₅₀ₖ/BA₄ₖ)-PBA₅₀ₖ-P(BA₄ₖ/MMA₅₀ₖ) (conditions: MMA/nBA/PnBA/Cu(I)/Cu(II)/dAbipy=1180/100/1/3.0//0.05/6.0; T=90° C., toluene 1.5 eq. vs MMA).

PBA macroinitiator (15.0 g, 0.30 mmol), MMA (37.8 ml, 0.35 mol), BA (4.30 ml, 0.03 mol), and toluene (35 mL) were added to a 205 ml Schlenk flask. Next, 4,4′-dinonyl-2,2′-bypyridyl (735 mg, 1.78 mmol), CuCl (89.1 mg, 0.90 mmol), CuCl₂ (2.0 mg, 1.5×10⁻² mmol) in purged anisole (20 ml) were added. The flask was placed in a preheated oil bath at 90° C. Samples were taken periodically, and the flask was opened to air after 50 h. After stirring at room temperature under an ambient atmosphere polymerization solution was diluted with THF and passed thru an alumina (activated neutral) column. A majority of the remaining monomer and solvent were removed by rotary evaporation, and the resulting solution was precipitated into methanol. The polymer was isolated, dissolved in THF, and reprecipitated into methanol. This process was repeated for a total of 3 reprecipitations. The final product was obtained with Mₙ=152,200, PDI=1.33.

The solution turned green due to oxidation of CuCl after 4 h and an addition of Sn(EH)₂ (1.2 eq. vs. initiator) was needed to reduce Cu(II) to Cu(I). As a result polydispersity slightly increased

Extension of PBA with MMA via normal ATRP (Run #WJ-04-37, 38 wt % BA)—PMMA₄ₖ-PBA₅₀ₖ-PMMA₄₀ₖ (conditions: MMA/PnBA/Cu(I)/Cu(II)/dAbipy=1000/1/3.0//0.05/6.0; T-90° C., toluene 1.5 eq. vs MMA). The same procedure as Run #WJ-04-36. The final product was obtained with Mₙ=142000, PDI=1.16.

### Example 5

### Preparation of Poly (N-Butyl acrylate-b-methymethacrylate)

ARGET ATRP of n-butyl acrylate and simultaneous chain extension with MMA, (Runs #WJ-04-15, 16, 17). This series of experiments were conducted with the assumption that the problem with crossover from a less active macroinitiator to a more active second monomer(s) could be circumvented by conducting a gradient copolymerization for the second block. The reactions directed at preparing the first macroinitiator block were stopped at different conversions of the first monomer by opening the Schlenk flasks to air to stop the polymerization reaction by oxidizing the catalyst complex to the deactivator state. An additional amount of anisole was added to each flask to lower the polymer solution viscosity; the flasks were closed, sealed and purged with nitrogen. After 10 min, MMA monomer was added along with an additional amount of the reducing agent (Sn(EH)₂) to reactivate the catalyst complex. The process flow for this simplified reaction would be the same as that shown in FIG. 1 with the absence of the flash drum and stripper for the first radically polymerizable monomer. All the conditions for these reactions (Runs #WJ-04-18, 19, 20) are shown in Table 3. The composition of the final diblock copolymers with a gradient A-block (PnBA-b-P(nBA-grad-MMA)) are different since different amounts of nBA (9, 24, 18%) remained in the system at the time of addition of MMA. In all cases bimodal distribution was observed. Note however in Run #WJ-04-19 there is strong evidence that a diblock copolymer was being formed, since it is clear that the MW was evolving and that all of the first macroinitiator had been incorporated into a diblock copolymer; the lower end of the trace of the final macroinitiator sample had cleanly moved to higher molecular weight. However for the preparation of high performance thermoplastic elastomers it is presently assumed that narrower molecular weight distribution A-blocks are desired therefore this behavior is still under investigation. Possibly the amount of catalyst is too low to activate and deactivate in an efficient way two different species.

TABLE 6

| Name of | | Mw | Mw | Conv. | Conv. | |
|---|---|---|---|---|---|---|
| sample | time | (GPC) | theor. | MMA | nBA | PDI |
| WJ-04-19 | 0 | 16800 | 16800 | 0 | 0 | 1.15 |
| | 90 | 18400 | 18000 | 0.13 | 0.02 | 1.21 |
| | 340 | 21400 | 19900 | 0.32 | 0.12 | 1.34 |
| | 1480 | 30300 | 26200 | 0.84 | 0.57 | 1.41 |

### Example 6

### Copolymerization of MMA and St Under ARGET Conditions

Different initiators act differently in ARGET ATRP processes. Not a big difference was observed between ethyl-2-bromopropionate (EtBP) and ethyl-2-bromoisobutyrate (EtBrIB) for polymerization of n-butyl acrylate. However, ARGET ATRP of methyl methacrylate with four different initiators, EtBP, EtBrIB, 2-bromopropionitrile (BrPN) and ethyl α-bromophenylacetate (EtBPA), provided significantly different polymers. See Table 7. Very active initiators, such as BrPN, in an ARGET ATRP process of MMA provided polymers with lower PDI and molecular weights closer to theoretical values.

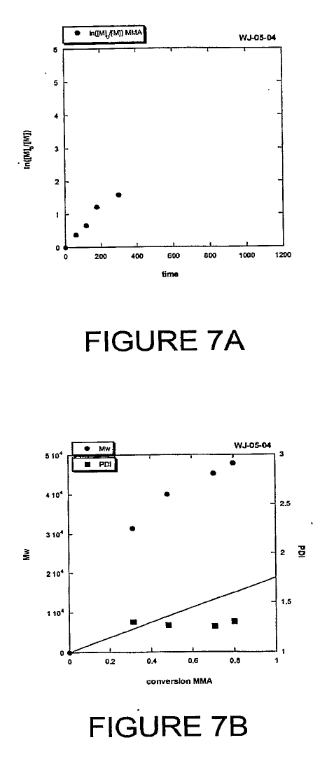

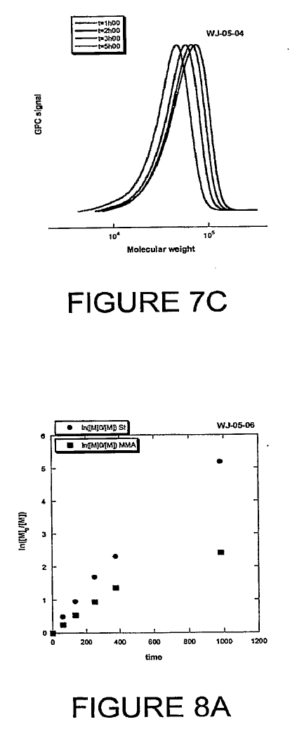

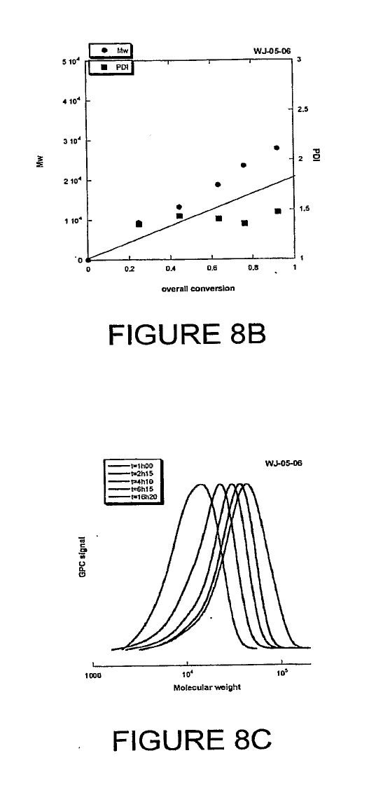

The polymerization conditions for the examples were constant and are presented in Table 7, in these examples: MMA/Ini/CuCl₂/TPMA/Sn(EH)₂=200/1/0.01/0.06/0.1; T=90° C., anisole 0.5 eq relative to monomer. FIGS. 7A-7C are plots of kinetic data for Run # WJ-05-04. FIGS. 7A and 8A shows that all polymerization proceeded at the similar rates. FIG. 7B shows evolution of molecular weights with conversion and polydispersity of obtained polymers.

These results suggest that cross-propagation from acrylate or styrene macroinitiators to methacrylates may provide block copolymer with higher molecular weight distributions. In order to increase initiation efficiency gradient transition blocks may be prepared, for example, MMA can be copolymerized with a relatively small amount of styrene. The presence of the styrene will slow down the reinitiation of macroinitiators formed during the polymerization of MMA to a rate comparable to the rate of initiation from the first initiator leading to lower molecular weight distributions.

TABLE 7
Example conditions and properties of PMMA prepared by an ARGET ATRP process.^{a}

| | | | Cu | | | | | Time | Conv. | | |
|---|---|---|---|---|---|---|---|---|---|---|---|
| Label | MMA | In | [ppm] | CuCl₂ | Ligand | Sn(EH)₂ | (min) | (%) | M_{n,theo}^{b} | M_{n,GPC} | M_{w}/Mₙ |
| WJ-05-02 | 200 | 1 PEBr | 50 | 0.01 | 0.06 | 0.1 | 300 | 0.82 | 16500 | 41500 | 1.35 |
| | | | | | TPMA | | | | | | |
| WJ-05-04 | 200 | 1 PEBr | 50 | 0.01 | 0.06 | 0.1 | 300 | 0.78 | 16000 | 47800 | 1.31 |
| | | | | | TPMA | | | | | | |
| WJ-04-86 | 200 | 1 EtBP | 50 | 0.01 | 0.06 | 0.1 | 240 | 0.79 | 15800 | 55700 | 1.33 |
| | | | | | TPMA | | | | | | |
| WJ-04-88 | 200 | 1 BrPN | 50 | 0.01 | 0.06 | 0.1 | 360 | 0.86 | 17200 | 16600 | 1.18 |
| | | | | | TPMA | | | | | | |

^{a}[MMA]₀/[In]₀ = 200; [MMA]₀ = 5.84 M; T = 90° C., in anisole (0.5 volume equivalent relative to monomer);
^{b}M_{n,theo} = ([M]₀/[In]₀) × conversion

TABLE 8
Example conditions and properties of P(MMA-co-St) prepared by an ARGET ATRP process, using PEBr as initiator.^{a}

| | | | | | | | | | Conv. | | | |
|---|---|---|---|---|---|---|---|---|---|---|---|---|
| | | | | Cu | | | | Time | (%) | | | |
| Label | MMA | St | In | [ppm] | CuCl₂ | Ligand | Sn(EH)₂ | (min) | MMA/St | M_{n,theo}^{b} | M_{n,GPC} | M_{w}/Mₙ |
| WJ-05-04 | 200 | — | 1 PEBr | 50 | 0.01 | 0.06 | 0.1 | 300 | 0.78/— | 16000 | 47800 | 1.31 |
| | | | | | | TPMA | | | | | | |
| WJ-05-06 | 180 | 20 | 1 PEBr | 50 | 0.01 | 0.06 | 0.1 | 980 | 0.91/0.99 | 18500 | 27800 | 1.48 |
| | | | | | | TPMA | | | | | | |
| WJ-05-05 | 160 | 40 | 1 PEBr | 50 | 0.01 | 0.06 | 0.1 | 1025 | 0.83/0.95 | 17300 | 28000 | 1.43 |
| | | | | | | TPMA | | | | | | |

^{a}[M]₀/[In]₀ = 200; [M]₀ = 5.84 M; T = 90° C., in anisole (0.5 volume equivalent relative to monomer);
^{b}M_{n,theo} = ([M]₀/[In]₀) × conversion

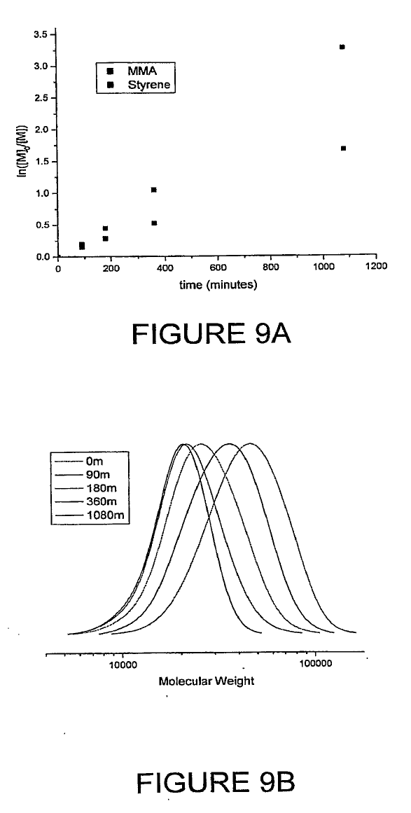

An embodiment of the polymerization process includes polymerizing methyl methacrylate with a radically polymerizable monomer that forms a less reactive dormant chain end, such as styrene, exemplified with a PEBr initiator. In an example of this embodiment, methyl methacrylate was copolymerized with 0%, 10% and 20% of styrene with PEBr as initiator. All the conditions for reactions and results are shown in Table 8-9 and in FIGS. 8A-8C for Run # WJ-05-06. In first example, Run #WJ-05-04, styrene based initiator was extended with pure MMA. It can be seen that molecular weights obtained from GPC were almost four times higher than theoretical values, although relatively low molecular weight distributions were observed (˜1.3). In next example, Run #WJ-05-06, MMA was copolymerized with 10% of styrene. Obtained molecular weights were much closer to theoretical values than in example without styrene monomer, although final polydispersity was higher than in polymerization with pure MMA. Increasing amount of St to 20% relative to MMA in ARGET ATRP using PEBr as initiator did not significantly improve the final results, molecular weight was only slightly higher than calculated value and PDI was higher (1.4) than in polymerization with pure MMA. See FIGS. 9A-9B.

TABLE 9

| Name of | | Mw | Mw | Conv. | Conv. | |
|---|---|---|---|---|---|---|
| sample | time | (GPC) | theor. | St | MMA | PDI |
| WJ-05-06 | 0 | 0 | 0 | 0 | 0 | 0 |
| | 60 | 9400 | 5000 | 0.39 | 0.23 | 1.36 |
| | 135 | 13300 | 9000 | 0.62 | 0.46 | 1.44 |
| | 250 | 18700 | 12800 | 0.82 | 0.61 | 1.41 |
| | 375 | 23500 | 15300 | 0.90 | 0.74 | 1.36 |
| | 980 | 27800 | 18500 | 0.99 | 0.91 | 1.48 |

### Example 7

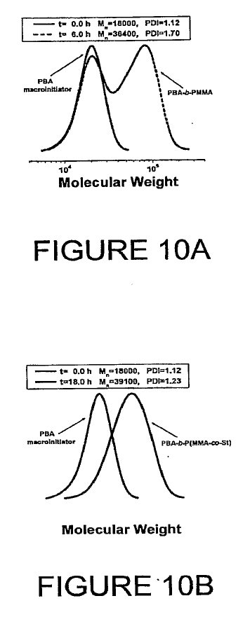

A poly(n-butyl acrylate with a number average molecular weight of 18,000 and a molecular weight distribution of 1.12 was used as a macroinitiator for the polymerization of second radically polymerizable monomer, styrene, and a third radically polymerizable monomer, methyl methacrylate. Styrene was used in concentrations of 10% styrene (LM-02-20) and with 0% St (LM-02-21). The polymerization conditions were as follows: [MMA]:[Sty]:[p(nBA)-Br]:[CuBr2]:[TPMA]:[Sn(EH)2]=180:20:1:0.01:0.06:0.1; Temperature=90° C., and 0.6 eq. anisole. With 0% styrene, the GPC of the formed polymer was clearly bimodal. See FIG. 10A. While with 10% styrene, a clean shift from the macroinitiator peak was observed. See FIG. 10B. However, there was an increase in PDI as the reaction progressed. Probably due to viscosity effects in the polymer as the Tg of the second block of the copolymer is close to 100° C.

The successful synthesis of block copolymers via ARGET ATRP where acrylate or styrene macroinitiators are used as the first block, and methacrylate is added as the second block has been reported. As halogen exchange could not be used for the ARGET system, styrene was used as a comonomer in the extension reaction to mediate propagation and provide efficient re-initiation of the dormant chain end. Model studies with small molecule acrylate and styrene-based initiators as well as computer simulations were used to determine that as little at 10 mol. % of styrene was needed to provide control. As evidenced by GPC, the extensions from poly(n-butyl acrylate) and polystyrene macroinitiators were successful. This method further extends the application of ARGET ATRP for potential industrial uses.

### Example 8

### Comparison of ARGET ATRP Process in DMF and Anisole

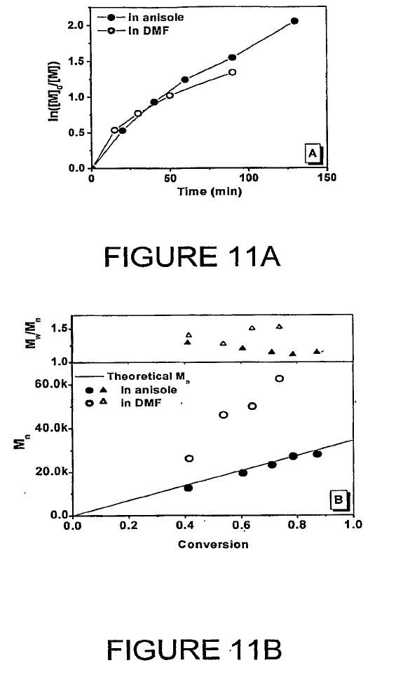

Table 10 illustrates results of an ARGET ATRP of methyl acrylate (MA) in the presence of various amounts of CuBr2/tris(2-(dimethylamino)ethyl)amine (Me6TREN) complexes and ascorbic acid under homogeneous conditions (in N,N-dimethylformamide (DMF)) and under heterogeneous conditions (in anisole in which ascorbic acid has limited solubility). Polymerization in DMF initially proceeded faster than that in anisole and led to polymers with higher polydispersity. This is especially noticeable in the polymerization when 250 ppm Cu was used: polymers were obtained with molecular weights, much higher than expected, indicating limited initiation efficiency. However, by changing the solvent to anisole, a significantly higher level of control was achieved. FIGS. 11A and 11B compares kinetics and evolution of molecular weights and polydispersities with conversion for two embodiments of the polymerization process in DMF and anisole. ARGET ATRP with ascorbic acid under heterogeneous conditions approached ˜80% MA conversion in less than 3 hours.

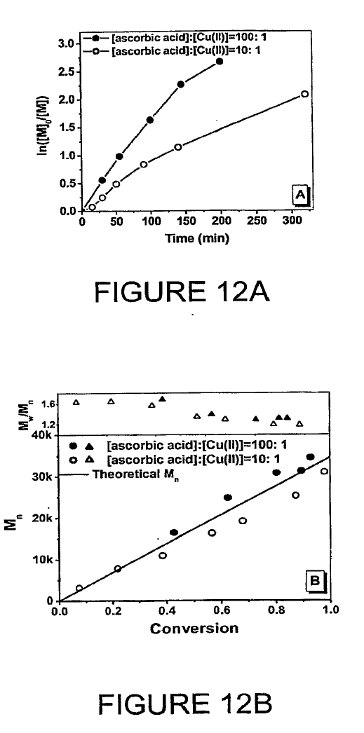

The experimental molecular weights, determined by GPC using polystyrene standards, were in good agreement with the theoretical values, indicating high initiation efficiency. The molecular weight distribution (MWD, Mw/Mn) remained 1.1-1.3 for the entire polymerization, indicating that control was quickly attained, and retained. The concentration of Cu may be further decreased to a lower level, e.g. 25 ppm, when anisole is used as solvent. When the reaction was carried out in DMF (Table 10, entry 3) the polymerization had lower initiation efficiency and broader MWD. The polymerization conducted in anisole (Table 10, entry 4) was well controlled. The monomer conversion increased to over 90% after 5 h, experimental molecular weights were in good agreement with the theoretical values, and the GPC traces symmetrically shifted to higher molecular weight, indicating high initiation efficiency. It was further observed that a higher amount of reducing agent, ascorbic acid, resulted in a higher polymerization rate, as illustrated in FIGS. 12A and 12B When the amount of reducing agent was 100 times higher than that of the Cu(II) catalyst (200 times higher than the stoichiometrical, amount), the polymerization reached over 90% MA conversion in ˜3 hours. The higher polymerization rate indicates that, in addition to a homogeneous reaction with sparingly soluble ascorbic acid, some contribution of the heterogeneous redox reaction between the Cu(II) catalysts and the surface of the solid ascorbic acid may also occur.

ARGET ATRP was also attempted with only 10 ppm Cu (Table 10, entry 6). The polymerization reached 90% conversion in 5 hours. This polymerization process had a significantly constant radical concentration and the relatively narrow MWD of the obtained polymers. All polymerizations carried out with 25 ppm or lower concentration of Cu resulted in the preparation of essentially colorless polymers; therefore, catalyst removal may not be necessary for some applications.

ARGET ATRP of n-butyl acrylate (BA), methyl methacrylate (MMA) and styrene (St) under homogeneous conditions with ascorbic acid as reducing agent was uncontrolled because of the too fast redox reaction. However, heterogeneous redox reactions were successful, as illustrated in Table 11. With 25 ppm Cu, polymers with polydispersity below 1.3 were prepared. For St, the polymerization temperature was increased to 90° C. in order to obtain an appropriate polymerization rate. In order to evaluate the retention of active chain-end functionality in the polymers, the macroinitiator prepared in entry 4, Table 10 (reaction was stopped at 98% conversion), was chain extended with styrene. High functionality was proved by the successful block copolymerization.

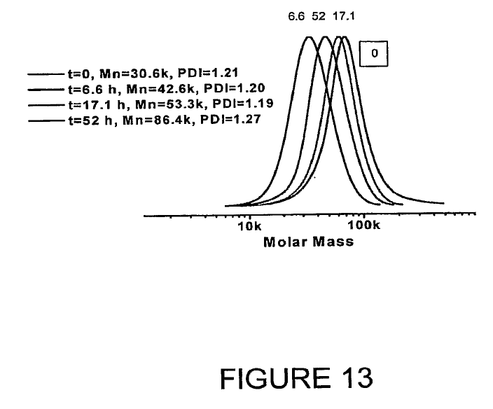

As FIG. 13 shows, the GPC traces of the block copolymer synthesis of poly(methyl acrylate) (PMA) by ARGET ATRP using ascorbic acid as reducing agent symmetrically shifted toward the higher molecular weight, indicating high cross-propagation efficiency.

In this embodiment, of the process the concentration of the reducing agent or availability of reducing agent was controlled by the solubility or surface area of a partially or poorly soluble active reducing agent in the reaction medium. The resulting continuously available low concentration of active reducing agent controlled the reduction of deactivator to activator and allowed generation of a suitable ratio of k_{act} to k_{deact} and thereby a controlled ATRP.

TABLE 10
Synthesis of poly(methyl acrytlate) (PMA) by an ARGET ATRP process
using ascorbic acid as reducing agent*

| Entry | Ascorbic Acid (to (Cu) | Cu (ppm)* | Solvent | Time (h) | Conv. | Mₙ (theo) | M_{n,GPC} | M_{w}/Mₙ |
|---|---|---|---|---|---|---|---|---|
| 1^{b} | 10 | 250 | DMF | 1.5 | 74% | 25460 | 62550 | 1.52 |
| 2^{b} | 10 | 250 | Anisole | 2.2 | 87% | 30000 | 28000 | 1.14 |
| 3^{c} | 10 | 25 | DMF | 3.3 | 87% | 30000 | 29400 | 1.60 |
| 4^{c} | 10 | 25 | Anisole | 5.3 | 87% | 30000 | 27700 | 1.19 |
| | | | | 1.7 | 98% | 33750 | 34000 | 1.18 |
| 5^{c} | 10 | 25 | | 3.3 | 93% | 32020 | 34400 | 1.30 |
| 6^{d} | 10 | 25 | | 6 | 91% | 31340 | 29700 | .40 |

*Polymerization temperature: 60° C. Polymerizations were carried out in 60% v/v solutions. Initiator: ethyl 2-bromisobuyrate (ERiB). Ligand Me₆TREN. The amount of ligand has been fixed at 10 times the amount of CU(II) initially added to the reaction in order to assure coordination of the ligand with Cu(II) in the presence of a large excess of monomer⁶.
^{a}Concentration of Cu: molar ratio of Cu to monomer.
^{b}[MA]:[I]:[Cu(II)] = 400:1:0.1;
^{c}[MA]:[I]:[Cu(II)] = 400:1:0.01;
^{d}[MA]:[I]:[Cu(II)] = 400:1:0.004.

TABLE 11
Synthesis of poly(methylacrylate) (PMA) by an ARGET ATRP process
using ascorbic acid as reducing agent*

| Entry | M | Ascorbic Acid (to (Cu) | Cu (ppm)* | Solvent | Time (h) | Conv. | Mₙ (theo) | M_{n,GPC} | M_{w}/Mₙ |
|---|---|---|---|---|---|---|---|---|---|
| 7^{b} | BA | 10 | 250 | Anisole | 21.5 | 89% | 45500 | 43000 | 1.28 |
| 9^{b} | MMA | 10 | 250 | Anisole | 18 | 59% | 23260 | 30700 | 1.27 |
| 9^{c} | St | 10 | 25 | Anisole | 64.7 | 68% | 27850 | 25200 | 1.18 |
| 10^{c} | St | 10 | 25 | Anisole | 52 | 55% | 53540 | 60900 | 1.27 |

*Polymerizations were carried out in 60% v/v solutions. Initiator: EBiB for FA and St, ethyl α-bromophenylacetate for MMA. Ligand: MeTREN. The amount of ligand has been fixed at 10 times the amount of Cu(II) initially added to the reaction.
^{a}concentration of Cu: molar ratio of Cu to monomer.
^{b}[M]:[I]:[Cu(II)]-400:1:0.01. Reaction temperature: 60° C.;
^{c}[M]:[I]:[Cu(II)] = 400:1:01. Reaction temperature: 90° C.;
^{d}[St]:[PMA-Br]:[Cu(II)] = 400:1:0.01. Reaction temperature: 90° C.

1. A polymerization process, comprising:
polymerizing first radically polymerizable monomers with an ATRP initiator in a reaction medium comprising a transition metal catalyst and a reducing agent, wherein the polymerizing first radically polymerizable monomers forms an ATRP macroinitiator;
oxidizing the transition metal catalyst to the deactivator state; and
initiating polymerization of second radically polymerizable monomers from the ATRP macroinitiator by adding further reducing agent to convert the catalyst in the deactivator state to catalyst in the activator state,
wherein a molar ratio of the transition metal catalyst to the ATRP initiator is less than 0.5.

2. The process of claim 1, comprising:
oxidizing the transition metal catalyst to the deactivator state after polymerization of the second radically polymerizable monomer.

3. The process of claim 2,
wherein initiating the polymerization of the second radically polymerizable monomers comprises initiating copolymerization of third radically polymerizable monomers and the second radically polymerizable monomers from the ATRP macroinitiator by adding further reducing agent to convert the catalyst in the deactivator state to catalyst in the activator state, wherein the second radically polymerizable monomers and the third radically polymerizable monomers are added prior to initiating the copolymerization.

4. The process of claim 1, wherein the transition metal catalyst is initially in a higher of two accessible oxidation states.

5. The process of claim 4, wherein the transition metal catalyst in a higher of two accessible oxidation states is reduced to a lower of the two accessible oxidation states by a redox reaction with the reducing agent.

6. The process of claim 5, wherein the reducing agent is soluble or partially soluble in the reaction medium.

7. The process of claim 5, wherein the reducing agent is insoluble in the reaction medium.

8. The process of claim 1, wherein the polymerizing one or more radically polymerizable monomers stops after oxidizing the transition metal catalyst, and the process comprises removing any unreacted first radically polymerizable monomers from the reaction medium.

9. The process of claim 8, wherein oxidizing the transition metal catalyst to the deactivator state occurs prior to the conversion of 100% of the first radically polymerizable monomers.

10. The process of claim 8, wherein oxidizing the transition metal catalyst to the deactivator state occurs prior to conversion of 80% of the first radically polymerizable monomers.

11. The process of claim 8, wherein oxidizing the transition metal catalyst to the deactivator state occurs prior to conversion of 70% of the first radically polymerizable monomers.

12. The process of claim 1, wherein the amount of reducing agent added is less than 10% greater than two times a molar amount of termination reactions.

13. The process of claim 1, comprising removing any unreacted first radically polymerizable monomers prior to initiating the polymerization of second radically polymerizable monomers.

14. The process of claim 3, wherein the degree of polymerization of the second monomer is less than 10 for each polymer chain.

15. The process of claim 3, wherein the rate of reactivation of a dormant chain end comprising the third monomer is comparable to the rate of activation of a dormant chain end comprising the first monomer and the PDI of the formed segment is less than 1.4.

16. The process of claim 1, comprising:
removing the unreacted first radically polymerizable monomers from the reaction medium;

17. The process of claim 1, comprising:
removing the unreacted first radically polymerizable monomers and unreacted second radically polymerizable monomers from the reaction medium;
adding a compound capable of reacting with a radical; and
adding further reducing agent to initiate a reaction between the polymer chains and the compound capable of reacting with a radical.

18. The process of claim 3, comprising:
removing the unreacted second radically polymerizable monomers and third radically polymerizable monomers from the reaction medium;
adding a compound capable of reacting with a radical; and
adding further reducing agent to initiate a reaction between the polymer chains and the compound capable of reacting with a radical.

19. The process of claim 16, wherein removing the first radically polymerizable monomer comprises distilling the first radically polymerizable monomers from the reaction medium.

20. The process of claim 19, wherein distilling the first radically monomers is performed under a vacuum.

21. The process of claim 1, wherein the molar ratio of the transition metal catalyst to the ATRP initiator is less than 0.1.

22. The process of claim 1, wherein the molar ratio of the transition metal catalyst to the ATRP initiator is less than 0.05.

23. The process of claim 1, wherein the molar ratio of the transition metal catalyst to the ATRP initiator is less than 0.01.
